(19) United States
(12) Patent Application Publication
(10) Pub. No.: US 2024/0004362 A1
(43) Pub. Date: Jan. 4, 2024

(54) METHOD FOR OPERATING A CONTROL DEVICE

(71) Applicant: Robert Bosch GmbH, Stuttgart (DE)

(72) Inventors: Achim Schaefer, Grossbottwar (DE); Guenther Stengel, Ludwigsburg (DE); Michael Klauss, Backnang (DE)

(21) Appl. No.: 18/344,072

(22) Filed: Jun. 29, 2023

(30) Foreign Application Priority Data
Jul. 4, 2022 (DE) 10 2022 206 816.5

(51) Int. Cl. G05B 19/042

(52) U.S. Cl. CPC G05B 19/0421

(57) ABSTRACT

A method for operating a control device, which has at least one arithmetic logic unit in which at least one real-time domain and at least one application domain are provided. An application is distributed over the at least one real-time domain and the at least one application domain. A basic synchronization event is generated in the at least one real-time domain and is transmitted to the at least one application domain such that synchronization is achieved between the at least one real-time domain and the at least one application domain

### CROSS REFERENCE

The present application claims the benefit under 35 U.S.C. § 119 of German Patent Application No. DE 10 2022 206 816.5 filed on Jul. 4, 2022, which is expressly incorporated herein by reference in its entirety.

### FIELD

The present invention relates to a method for operating a control device and to a control device of this kind.

### BACKGROUND INFORMATION

Control devices are electronic modules installed at different points in technical equipment, for example motor vehicles, so as to control technical processes and technical components in an open- and/or closed loop manner. In modern motor vehicles, a multiplicity of control devices are installed, and at least some of these are subject to strict requirements in terms of safety. One possible use is in conjunction with driver assistance systems or advanced driver assistance systems (ADAS).

The increasing computing power requirements in present-day ADAS and centralized vehicle computer architectures necessitate the use of highly integrated single-chip or system-on-chip (SoC) systems or even systems having a plurality of SoCs in one control device or electronic control unit (ECU). Single-chip systems should be understood as the integration of all or many of the functions of a programmable electronic system on one chip, i.e., in an integrated circuit on a semiconductor substrate.

These SoCs implement various types of in particular heterogeneous processing or processor cores, hardware accelerators, safety elements, inputs and outputs (I/O), communication equipment, etc. The relevant hardware elements (HW elements) in the context of the method presented herein are the universal processor cores, in which the majority of the application logic is housed. There are typically two types of said universal cores:

1. Real-Time or Runtime Cores (RT)

Typical Parameters or Attributes:
highest level of safety up to ASIL-D, hardware lockstep
optimized precision or high precision for I/O: analog-to-digital converter (ADC), general-purpose input/output (GPIO)
support for special automotive communication networks, for example CAN, Flexray, Ethernet, SPI
moderate performance
running of bare-metal operating systems and Classic AUTOSAR Stack
deterministic execution behavior
deterministic I/O processing, e.g., homogeneous sampling
implementation of cyclical rate-monotonic task scheduling with time sharing

Hardware (HW) lockstep is a safety measure for achieving a higher ASIL (→D). For this purpose, critical HW elements, for example the computing core, are implemented with redundancy.

“Bare-metal” typically means that the software runs directly on the hardware without a relatively large abstraction layer. This should be understood in particular to mean that a small “simple” operating system or scheduler is run, thus having a reduced functional scope compared with a complete POSIX operating system, for example. A reduced operating system of this kind is also used in the context of Classic AUTOSAR.

2. Application Processing Cores (AP)

Typical Properties:
only a limited safety level (ASIL) possible, up to ASIL-A/B
running of a powerful, function-rich or feature-rich Portable Operating System Interface (POSIX) operating system, for example QNX, GHS, Windriver, Linux
possibility to run an adaptive AUTOSAR stack
very high processing or computing performance
typically based on POSIX event-based programming paradigms and best-possible division of work
flexible service-oriented architecture (SOA)
support for high-performance, complex software application frameworks, whether proprietary or open source, for example GPU, frameworks, HW accelerators

In previous systems, the applications run relatively independently on either the RT domain or the AP domain, and quite often on their own chips. In cases where there is interaction between the two domains, the interaction has thus far been very loosely coupled, for example via I/O connections between them or a clear separation of tasks, e.g., a safety watchdog on RT, application on AP or main logic on RT and only graphic-algorithm processing on AP.

Due to the requirements on the performance of future ADAS and central vehicle computer architectures, the application logic has to be apportioned and distributed over the available domains, either on a single SoC or even on a plurality of SoCs. This development process has to take account of the different domain properties set out above; in most cases this results in a closely coupled system and requires a particular type of synchronization and communication determinism between the domains, which was not needed in older systems.

In addition, the need for POSIX-based operating systems and application frameworks on the AP domain means that some additional mechanisms are required compared with previous systems. The POSIX-based systems typically follow an event-based programming/design paradigm using a time-sharing strategy for the best utilization. The application creates chains or sequences of events over a plurality of processes or threads, which execute the various sub-algorithms in synchronization. This is different from the highly safety-critical or data-driven embedded systems on the RT domain, which have a cyclical task schedule, which involves fixed priorities and thus high determinism in consideration of the execution and I/O. Thus, the challenge is to combine the deterministic behavior on the RT domains with the flexibility of the AP environments.

German Patent Application No. DE 10 2020 213 378 A1 describes a method for controlling a technical system. The method uses a mechanism which is implemented in at least one hardware module or peripheral component by way of which jobs from a plurality of partitions or applications can be placed. These cannot be overwritten or influenced by other partitions or applications. In the method, deterministic runtime behavior of at least one application is taken into account.

### SUMMARY

According to the present invention, a method and a control device are provided. Specific example embodiments of the present invention are disclosed herein.

The method according to the present invention is used for operating a control device, which has at least one arithmetic logic unit in which at least one real-time domain and at least one application domain are provided. According to an example embodiment of the present invention, in the method, an application is distributed over the at least one real-time domain and the at least one application domain, wherein a basic synchronization event, also referred to as a basic synchronization cycle, is generated in the at least one real-time domain and is transmitted to the at least one application domain such that synchronization is achieved between the at least one real-time domain and the at least one application domain.

Distributing an application over the at least one real-time domain and the at least one application domain means that parts of the application are on the real-time domain and the other parts are on the application domain and thus the program is executed on both domains.

Therefore, what is described according to the present invention is a mechanism by which both types of domain, namely AP and RT, are deterministically synchronized both in one SoC and in a plurality of SoCs, without restricting the natural properties of each domain. This means that the cyclically deterministic system on the RT domain and the event-based signal sequences on the AP side are retained. As a result, it is possible to configure application signal sequences that bridge the various domain boundaries and make use of the best properties of each side.

Underlying communication and event determinism allows the application to achieve the full degree of determinism required and/or more deterministic systems based on this approach.

The method according to the present invention can be executed on a plurality of arithmetic logic units. In this case, one of the arithmetic logic units can function as the primary arithmetic logic unit and the other arithmetic logic units can function as secondary arithmetic logic units, wherein the primary arithmetic logic unit injects the basic synchronization event into one or more secondary arithmetic logic units.

In addition, single-chip systems (SoC) can be used as arithmetic logic units.

Furthermore, according to an example embodiment of the present invention, at least parts of the application can be synchronized with a basic synchronization event. In one embodiment of the present invention, the entire application is synchronized with the basic synchronization event.

It should be noted that usually both domains, namely RT and AP, run independently of one another with only a very minor degree of coupling. Real-time applications are typically executed on the RT cores; non-real-time applications are executed on the AP cores. Synchronization is carried out only very loosely by a network level or layer. Each domain targets applications that benefit from the principally supported features. By way of example, this concerns safety, deterministic execution, and deterministic signal sequences (RT) versus high performance, flexibility of features, and event sequences (AP).

The method according to an example embodiment of the present invention implements event and data synchronization between the two domains, thereby allowing signal sequences to be distributed over said two domains. The main advantage of this is that the two domains are not forced to behave in the same way, which would restrict the intrinsic features of each environment, for example only one cycle schedule on POSIX. On the contrary, each domain retains its strengths and contributes to a communication determinism that is needed for such distributed applications.

This may make it possible to configure applications that benefit, for example, from the highest real-time safety and a maximally deterministic subsystem on the RT domain and from the flexible, event-controlled features of the AP domain. This is the key to all forthcoming safety-related and/or determinism-based applications, for example ADAS or other central control devices, which require extremely high performance and run on ultra-modern highly integrated SoCs. It should be borne in mind that these can no longer be executed on a single domain.

Uses of the application and system are, for example, safety-relevant distributed applications or secure basic services for exchanging data and monitoring and controlling the domains and entities in order to deterministically obtain the entire fault tolerant time interval (FTTI). This is also advantageous for systems that are not subject to any safety requirements but which comprise complex data processing and thus deterministic signal sequence requirements, since it is now possible to interconnect the RT- and AP-specific accelerators and I/O elements in a deterministic way.

According to the present invention, the same mechanism can also be used in control devices that have a plurality of functionally dependent SoCs. In this case, the primary SoC will mirror the basic synchronization event for the various SoCs and the domains inside the SoCs.

Conventional solutions provide options for synchronizing timing charts on various control devices, which restricts flexibility, in particular in POSIX-based systems. By contrast, the solution proposed herein according to an example embodiment of the present invention works differently since it supports various superposed schedule types on both sides, but typically not necessarily in a cyclical, rate-monotonic manner with time sharing on the RT side and event-controlled chains or sequences on the AP side. All the schedules can be synchronized flexibly at particular points, allowing for the configuration of further deterministic frameworks which range from complete, highly static tasks and data synchronization to merely data sequence-driven synchronization.

Further advantages and embodiments of the present invention become apparent from the description and the figures.

It goes without saying that the features described above and hereinafter can be used not only in the combination stated, but also in other combinations or in isolation, without departing from the scope of the present invention.

### BRIEF DESCRIPTION OF THE DRAWINGS

FIG. 1 is a block diagram of an embodiment of a control device configured for carrying out a specific embodiment of the method according to the present invention.

FIG. 2 is a diagram showing event cycle synchronization from RT to AP, according to an example embodiment of the present invention.

FIG. 3 is a diagram showing event cycle synchronization from AP to RT, according to an example embodiment of the present invention.

### DETAILED DESCRIPTION OF EXAMPLE EMBODIMENTS

The present invention is illustrated schematically in the figures on the basis of specific embodiments and will be described in detail below with reference to the figures.

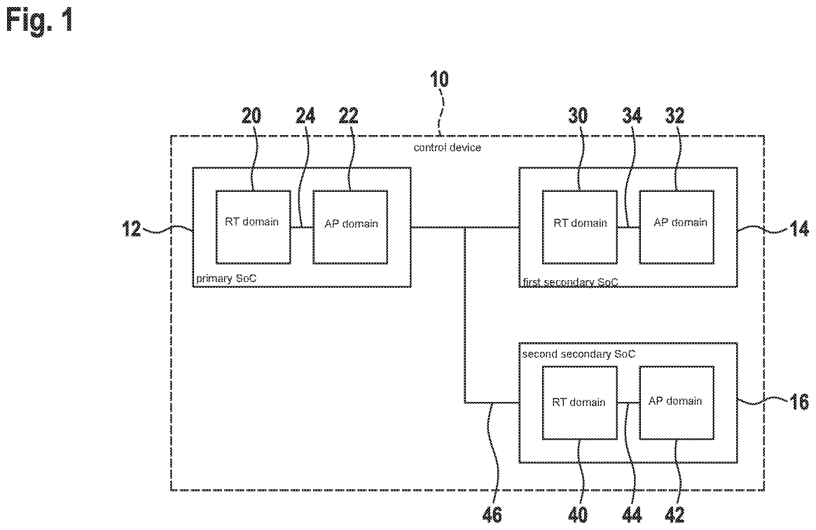

FIG. 1 is a block diagram of a control device, which is denoted overall by reference numeral 10. In this control device 10, a primary SoC 12, a first secondary SoC 14, and a second secondary SoC 16 are provided. In the primary SoC 12, a real-time (RT) domain 20, which comprises microcontroller cores, and an application (AP) domain 22, which comprises microprocessor cores, are provided. These two domains 20 and 22 are interconnected by means of a connection 24 for inter-domain communication and notifications.

In the first secondary SoC 14, an RT domain 30, which comprises microcontroller cores, and an AP domain 32, which comprises microprocessor cores, are provided. These two domains 30 and 32 are interconnected by means of a connection 34 for inter-domain communication and notifications. In the second secondary SoC 16, an RT domain 40, which comprises microcontroller cores, and an AP domain 42, which comprises microprocessor cores, are provided. These two domains 40 and 42 are interconnected by means of a connection 44 for inter-domain communication and notifications.

Connections 46 for inter-domain communication and notifications are also provided between the primary SoC 12 and the two secondary SoCs 14 and 16.

In the method being presented according to the present invention, it is now provided that a basic synchronization event is introduced between the real-time domain (RT) and the application domain (AP). For systems comprising a plurality of SoCs, said basic synchronization event is made available among the various SoCs. This basic synchronization event or event cycle, which is deterministic for all the domains, can be used for various purposes:
data synchronization: sending and receiving data in a deterministic way
event synchronization: exchanging events in a deterministic way, for example safety status information and status queries
configuring algorithms based on homogeneous or equidistant sampling I/O
configuring further deterministic frameworks, from highly static time-shared data and task synchronization to more flexible signal sequences based on data exchange synchronization

Typically, the RT cores drive a cyclical task schedule, which is used to sample the input data and provide an output having a low jitter. When these raw or pre-processed data have been exchanged on said event cycle, the maximum latency can be derived and observed by the applications running on the AP cores. This thus ensures that the event sequences on the AP cores receive the data in a deterministic way. This functions in the same way the other way around, i.e., from AP to RT: the output data are sampled by a number of transfer apparatuses or gateways on the AP core and, on the basis of the event cycle, are sent to the RT cores where they are processed and output further.

The main advantage of this event cycle is its flexibility:
Signal and event sequences can be set up and configured specifically for each application.
Different signal sequences and applications can be linked or interleaved and executed at the same time.
The basic synchronization cycle can be set up independently of the specific data transfer time of the individual applications since decisions on which event cycle to synchronize with can be taken at system and application level. This is ideal for platform frameworks.
The latency is short since the basic synchronization event or event cycle is independent of the transmitted data and is not globally defined for or adjusted to the system.
Applications that do not require determinism can run freely in parallel, for example for comfort applications.
An AP domain/POSIX system can still use its event sequences and merely make use of the core cycle as a new data event trigger.
This allows for deterministic coupling and for communication between the more traditional RT domain (cycle task) and the more advanced, event-driven AP domain.

The subsequent figures show the basic principles of this core-event synchronization.

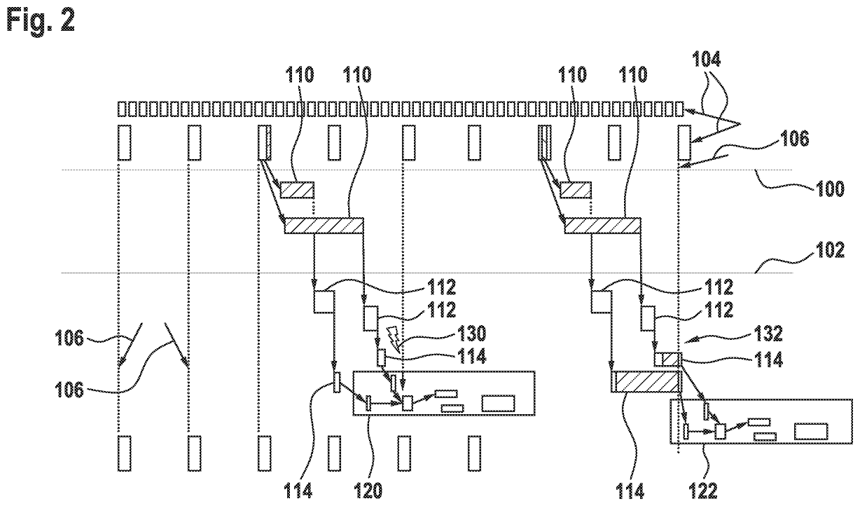

FIG. 2 is a diagram showing the event cycle synchronization from RT to AP. The illustration shows the real-time (RT) domain 100 and the application (AP) domain 102. Arrows 104 illustrate the RT cycle task schedule. Further arrows 106 illustrate a basic synchronization event. Also shown are hardware communication 110, a POSIX driver, a processing stack 112, a gateway 114, a first application framework 120, and a second application framework 122. A first option 130 illustrates synchronization of a plurality of input channels within the application. A second option 132 illustrates synchronization of a plurality of input channels in the gateway.

The cyclical tasks denoted by reference numeral 104 run on the RT domain 100. On the basis of these tasks, the transmissions via the hardware communication 110 are initiated, and these also specify the basic synchronization event 106. The data transfer in hardware between the RT domain 100 and the AP domain 102 takes place via the hardware communication 110. The transmission takes different amounts of time depending on both the quantity of data to be transmitted and the medium (rate/bandwidth). The medium may be, for example, Ethernet or shared memory. The processing stack 112 forms parts of the operating system, in particular the driver and service layers. The gateway 114 is a software component that is independent of the operating system and, for example, supplies the data from the operating system driver or communication stacks into the application framework. Synchronization with the basic synchronization event can be carried out at this location or in the application framework 120. The application framework 122 includes the business logic and is typically implemented in an event-based manner.

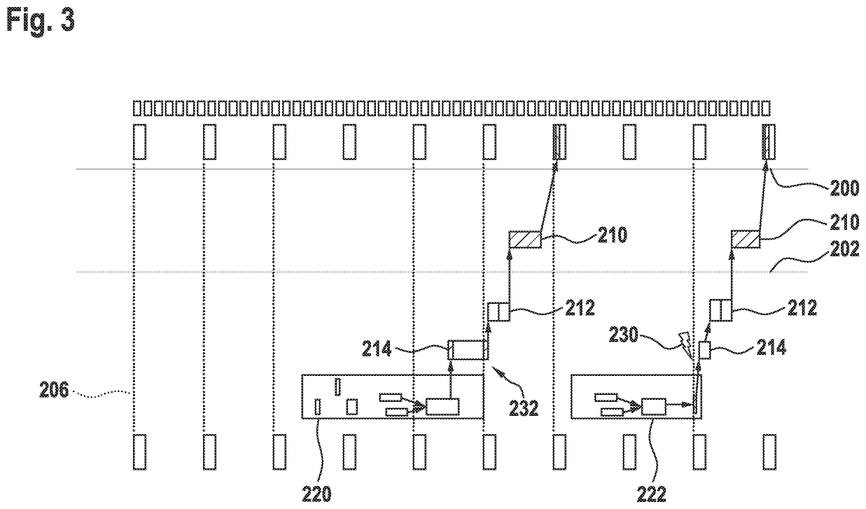

FIG. 3 is a diagram showing the event cycle synchronization from AP to RT. The illustration shows the real-time (RT) domain 200 and the application (AP) domain 202. Reference numeral 206 illustrates a basic synchronization event. Also shown are hardware communication 210, a POSIX driver, a processing stack 212, a gateway 214, a first application framework 220, and a second application framework 222. A first option 230 illustrates synchronization of output channels within the application. A second option 232 illustrates synchronization of output channels in the gateway.

In both FIGS. 2 and 3, the top part illustrates the RT domain with a cycle task schedule running thereon. It should be noted that only two cyclical tasks are shown here and that other event-based tasks, interruptions, or cyclical tasks have been omitted for simplicity. The middle part shows the hardware layer, i.e., typically the application communication channels between the domains or between the SoCs. This may relate to jointly used memories for inter-domain communication or Ethernet, PCIe, SPI, etc. for inter-SoC communication.

The lower part shows the AP domain having the POSIX application and the POSIX driver, i.e., I/O stack, communication stack, etc. The application and the POSIX driver follow the event-based design paradigms, as is commonplace for such environments.

On the basis of its deterministic cycle task schedule, the RT domain generates said basic synchronization event, which is mirrored for the AP domain.

FIG. 2 shows the use in which data are transmitted from RT to AP, on the assumption that parts of the application logic are saved on both the RT and AP side. The application on the RT side is, for example, sampling I/O data and requires the data to be provided on the AP side, where the main application logic runs.

If the AP side were to start processing the data as soon as they arrived, this would lead to a solely event-driven system, which has various drawbacks for safety-critical systems, for example the worst-case execution time, undesirable displacement scenarios, or beat effects. This would make the system as a whole very complex and prone to errors, particularly if a plurality of event sequences run in parallel. The proposed solution now makes it possible to synchronize the various, in particular long-running, AP application event sequences with the basic synchronization event, thereby ensuring that the data arrived deterministically and that the main application logic adopts equidistant behavior. The figure shows various options for feeding this event cycle into the application. By way of example, this can be done on the communication gateway or directly within the application. Furthermore, it is possible to consolidate various input streams and introduce them into the AP application space deterministically.

The same principles are applicable if the data return to the RT domain from the AP domain, as can be seen in FIG. 3. The same problems as mentioned above, for example beat effects, would be noted in the non-synchronized or non-deterministic case. This would lead to a system load and displacement problems that are intolerable for safety-critical systems. If the event sequence uses the basic synchronization event, it can be ensured that the data arrive deterministically in the same time window on the RT side, which is important for further processing, for example in terms of network output or hardware I/O handling.

This event cycle handling is relatively flexible. Distributed applications can be positioned at the synchronization points, depending on requirements. Various signal sequences between RT and AP can run simultaneously since they are not displaced into a global data exchange window. Moreover, the duration of the hardware transmission, which may differ between the signal sequences, can be observed by the application logic, for example when synchronizing with cycle=n or waiting for cycle=n+1, and need not be defined centrally, thereby reducing the overall latency. As a result, the optimum for each signal sequence can be achieved.

The event synchronization channel as shown in FIG. 1 can be implemented by means of various HW mechanisms available for each SoC. In this context, a distinction should be drawn between domains and SoCs. These hardware mechanisms are, for example:
notifications: interruptions over core boundaries, general-purpose I/O (GPIO), timer unit
monitoring or control information: jointly used memory, (virtual) Ethernet, PCIe, SPI, UART, I²C

The control hierarchy for maximum precision is the RT domain that controls the AP domain of each SoC, and the primary RT domain that monitors or controls the secondary RT domain.

What is claimed is:

1. A method for operating a control device, which has at least one arithmetic logic unit in which at least one real-time and at least one application domain are provided, the method comprising the following steps:
distributing an application over the at least one real-time domain and the at least one application domain; and
generating a basic synchronization event in the at least one real-time domain, and transmitting the basic synchronization event to the at least one application domain such that synchronization is achieved between the at least one real-time domain and the at least one application domain.

2. The method as recited in claim 1, wherein the method is executed on a plurality of arithmetic logic units.

3. The method as recited in claim 2, wherein one of the arithmetic logic units functions as a primary arithmetic logic unit and the other arithmetic logic units function as secondary arithmetic logic units, wherein the primary arithmetic logic unit injects the basic synchronization event into one or more of the secondary arithmetic logic units.

4. The method as recited in claim 2, wherein the arithmetic local units are single-chip systems.

5. The method as recited in claim 1, wherein at least parts of the application are synchronized with the basic synchronization event.

6. The method as recited in claim 1, wherein the method is carried out for a control device that is provided for controlling a system selected from a group including the following: driver assistance systems, industrial manufacturing facilities, systems for transport and data control.

7. The method as recited in claim 1, wherein the method is used for synchronizing data.

8. The method as recited in claim 1, wherein the method is used for synchronizing events.

9. The method as recited in claim 1, wherein the method is used for configuring algorithms.

10. The method as recited in claim 1, wherein the method is used for configuring deterministic frameworks.

11. A control device having at least one arithmetic logic unit in which at least one real-time and at least one application domain are provided, the control device configured to:
distribute an application over the at least one real-time domain and the at least one application domain; and
generate a basic synchronization event in the at least one real-time domain, and transmit the basic synchronization event to the at least one application domain such that synchronization is achieved between the at least one real-time domain and the at least one application domain.

12. The control device as recited in claim 11, wherein the control device includes a number of single-chip systems.
